(19) United States
(12) Patent Application Publication
(10) Pub. No.: US 2011/0317449 A1
(43) Pub. Date: Dec. 29, 2011

(54) ALTERNATING CURRENT REGULATING MEANS

(76) Inventor: Chao-Lin Wu, Kaohsiung City (TW)

(21) Appl. No.: 12/823,094

(22) Filed: Jun. 24, 2010

(51) Int. Cl. H02M 7/02; G05F 3/02

(52) U.S. Cl. 363/13; 323/304

(57) ABSTRACT

The present invention provides an alternating current regulating means including a positive half-cycle current-limiting circuit and a negative half-cycle current-limiting circuit. The positive half-cycle current-limiting circuit includes a first diode and a first current-limiting circuit. The negative half-cycle current-limiting circuit includes a second diode and a second current-limiting circuit. The first diode allows the positive half-cycle current of the alternating current to pass through, and the second diode allows the negative half-cycle current of the alternating current to pass through. Thus, when the input power supply generates an alternating current, the first diode and the second diode respectively allow the positive half-cycle current and the negative half-cycle current of the alternating current to pass through. Then, the first current-limiting circuit and the second current-limiting current respectively process the positive half-cycle current and the negative half-cycle current, so that the average current value of the outputted alternating current can be restricted to a stable value for a load.

### BACKGROUND OF THE INVENTION

1. Field of the Invention

The present invention relates to an alternating current regulating means, and in particular to a means for outputting a stable electric current.

2. Description of Prior Art

A load means an object which consumes electricity for its operation, such as a television, air conditioner, electric fan or the like. Since the electricity generated by a power plant is delivered over long distances to an end user and electric cables used for delivering the electricity inevitably have a large internal resistance, the electric current reaching the end user is unstable, which may adversely affect the lifetime of the load device. In particular, some delicate or precision load devices may suffer damage due to the unstable input electric current.

Therefore, current-regulating means have been proposed. One end of the current-regulating means is electrically connected to a power supply, and the other end thereof is electrically connected to a load. After an electric current passes through the current-regulating means, the electric current can be regulated to provide a stable current for the load.

However, the conventional current-regulating means has a drawback. That is, the input electric current has to be a direct current, or otherwise the conventional current-regulating means cannot generate a stable current. Since the power supply in a house or a factory generates an alternating current, the conventional current-regulating means cannot be directly used in home or factory settings.

Since the conventional current-regulating means has the above-mentioned problems, the present Inventor tries to solve the problems in prior art.

### SUMMARY OF THE INVENTION

In order to solve the problems of the conventional current-regulating means, the present Inventor proposes a novel and reasonable structure based on his research and experiments.

The present invention relates to an alternating current regulating means, which includes:

a positive half-cycle current-limiting circuit comprising a first diode, a first current-limiting circuit, a first input end and a first output end, a cathode of the first diode being electrically connected to an input end of the first current-limiting circuit, an anode of the first diode being electrically connected to the first input end, an output end of the first current-limiting circuit being electrically connected to the first output end;

a negative half-cycle current-limiting circuit comprising a second diode, a second current-limiting circuit, a second input end and a second output end, an anode of the second diode being electrically connected to an input end of the second current-limiting circuit, a cathode of the second diode being electrically connected to the second input end, an output end of the second current-limiting circuit being electrically connected to the second output end;

a current input section, one end of the current input section being electrically connected to the first input end and the second input end and coupled to a first connecting point, the other end of the current input section being electrically connected to an input power supply; and

a current output section, one end of the current output section being electrically connected to the first output end and the second output end and coupled to a second connecting point, the other end of the current output section being electrically connected to a load.

According to the present invention, one end of the alternating current regulating means is electrically connected to the input power supply, and the other end thereof is electrically connected to the load. When the input power supply generates an alternating current flowing to the first connecting point, the first diode allows the positive half-cycle current of the alternating current to pass through, and the second diode allows the negative half-cycle current of the alternating current to pass through. As a result, the alternating current is divided into the positive half-cycle current flowing into the first current-limiting circuit and the negative half-cycle current flowing into the second current-limiting circuit. The difference of phase angle between the positive half-cycle current and the negative half-cycle current is 180 degree. Thus, the positive half-cycle current flowing to the first current-limiting circuit is outputted to the second connecting point with a stable and constant value, and the negative half-cycle current flowing into the second current-limiting circuit is output to the second connecting point with a stable and constant value. Since the difference of the phase angle between the positive half-cycle current and the negative half-cycle current is 180 degree; the positive half-cycle current and the negative half-cycle current flow to the second connecting point to form an electric current having a continuous periodic wave for the load. In this way, the problem that the conventional current-regulating means only regulates a direct current to become a stable output current can be solved.

### BRIEF DESCRIPTION OF THE DRAWINGS

FIG. 1 is a schematic view of the present invention;

FIG. 2 is a schematic view showing a positive half-cycle current-limiting circuit of an embodiment of the present invention;

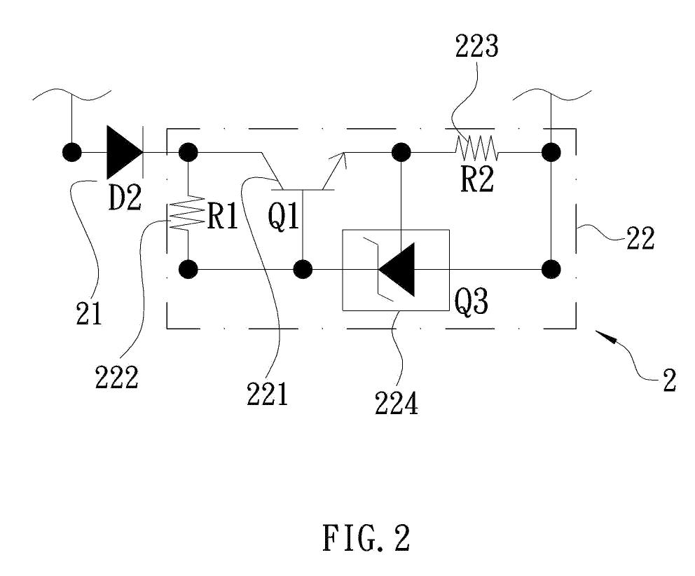

FIG. 3 is a schematic view showing a negative half-cycle current-limiting circuit of an embodiment of the present invention; and

FIG. 4 is a schematic view showing an embodiment of the present invention.

### DETAILED DESCRIPTION OF THE INVENTION

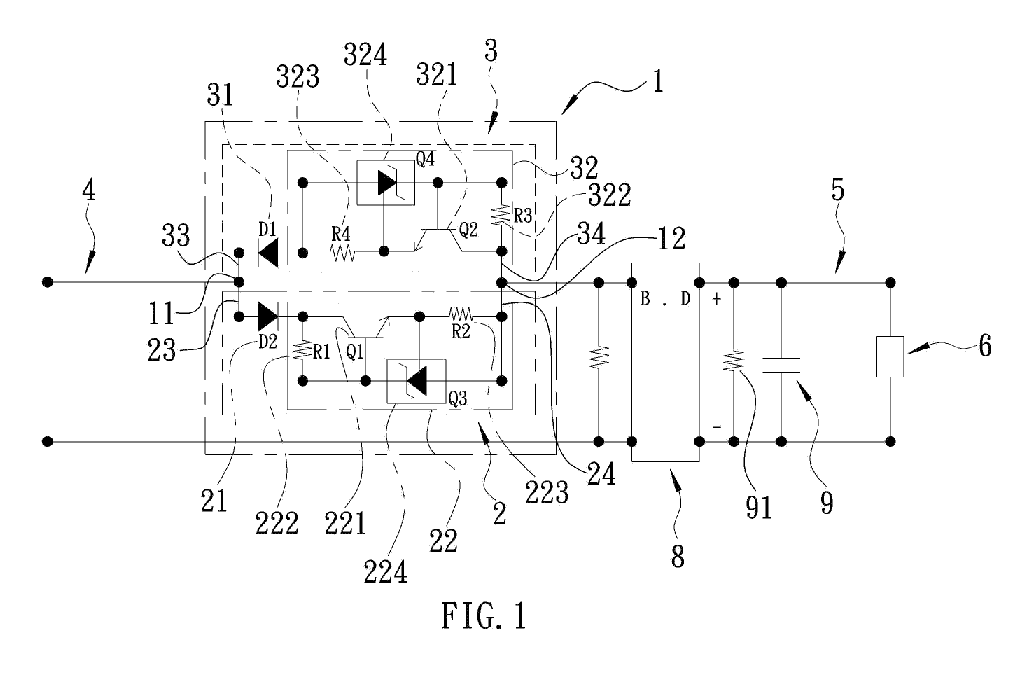

Please refer to FIG. 1. The present invention is directed to an alternating current regulating means (1), which includes a positive half-cycle current-limiting circuit (2), a negative half-cycle current-limiting circuit (3), a current input section (4), and a current output section (5).

The positive half-cycle current-limiting circuit (2) comprises a first diode (21), a first current-limiting circuit (22), a first input end (23) and a first output end (24). A cathode of the first diode (21) is electrically connected to an input end of the first current-limiting circuit (22). An anode of the first diode (21) is electrically connected to the first input end (23). An output end of the first current-limiting circuit (22) is electrically connected to the first output end (24). With this arrangement, when the first input end (23) is electrically connected to an input power supply generating an alternating current, the first diode (21) allows the positive half-cycle current of the alternating current to pass through but obstructs the passage of the negative half-cycle current of the alternating current. As a result, only the positive half-cycle current of the input power supply can flow into the first current-limiting circuit (22), and then the first current-limiting circuit (22) makes the positive half-cycle current to become a stable valve.

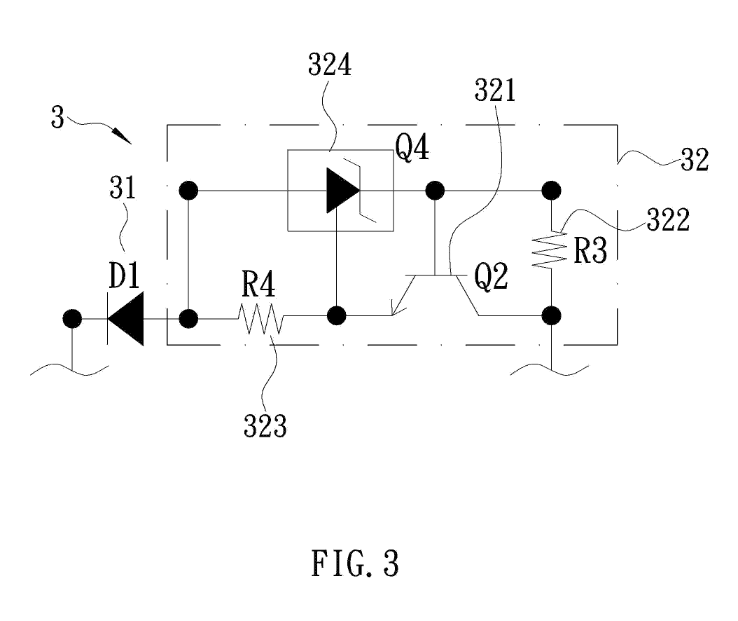

Please refer to FIGS. 1 and 3, which show a preferred embodiment of the positive half-cycle current-limiting circuit (2). The first current-limiting circuit (22) includes a first bipolar junction transistor (221), a first bias resistor (222), a first current-limiting resistor (223), and a first voltage-regulating unit (224). The first bipolar junction transistor (221) is electrically connected to the input end of the first current-limiting circuit (22). One end of the first bias resistor (222) is electrically connected to a base of the first bipolar junction transistor (221), and the other end of the first bias resistor (222) is electrically connected to the input end of the first current-limiting circuit (22). The first voltage-regulating unit (224) is electrically connected to the base of the first bipolar junction transistor (221), the output end of the first current-limiting circuit (22), and an emitter of the first bipolar junction transistor (221). The first voltage-regulating unit (224) is configured to control the current value output by the emitter of the first bipolar junction transistor (221). One end of the first current-limiting resistor (223) is electrically connected to the first voltage-regulating unit (224), and the other end of the first current-limiting resistor (223) is electrically connected to the output end of the first current-limiting circuit (22). A preferred embodiment of the first voltage-regulating unit (224) is a controllable Zener diode (also referred to as “TL431”). An anode of the controllable Zener diode is electrically connected to the output end of the first current-limiting circuit (22), and a cathode of the controllable Zener diode is electrically connected to the base of the first bipolar junction transistor (221). A reference end of the controllable Zener diode is electrically connected to the input end of the first current-limiting resistor (223). Hereinafter, the first voltage-regulating unit (224) is described by using the controllable Zener diode as an example.

When the positive half-cycle current of the alternating current flows through the first diode (21) and into the first current-limiting circuit (22), the positive half-cycle current flows through a collector of the first bipolar junction transistor (221) and reaches the emitter of the first bipolar junction transistor (221). The value of the current reaching the emitter depends on the first bias resistor (222). When the positive half-cycle current flows through the current-limiting resistor (223), both ends of the current-limiting resistor (223) will generate a voltage Ve-r. The breakdown voltage of the first voltage-regulating unit (224) is defined as Vz. If Ve-r>Vz, the first voltage-regulating unit reduces the bias voltage output by the first bipolar junction transistor (221), so that the output current of the first bipolar junction transistor (221) can be limited to an average current value. Therefore, when the resistance of the bias resistor (222) and the current-limiting resistor (223) is changed, the average current value of the positive half-cycle current can be controlled. Since the first current-limiting circuit (22) of the present embodiment is constituted of fewer elements, the total manufacturing costs are reduced to make the present invention more competitive. Furthermore, the manufacturing procedure is also simplified.

The negative half-cycle current-limiting circuit (3) comprises a second diode (31), a second current-limiting circuit (32), a second input end (33) and a second output end (34). An anode of the second diode (31) is electrically connected to an input end of the second current-limiting circuit (32). A cathode of the second diode (31) is electrically connected to the second input end (33). With this arrangement, when the second input end (33) is electrically connected to an input power supply generating an alternating current, the second diode (31) allows the negative half-cycle current of the alternating current to pass through but obstructs the passage of the positive half-cycle current of the alternating current. The output end of the second current-limiting circuit (32) is electrically connected to the second output end (34). The second current-limiting circuit (32) allows the negative half-cycle current to pass through to become a stable valve.

Please refer to FIGS. 1 and 3, which show a preferred embodiment of the negative half-cycle current-limiting circuit (3). The second current-limiting circuit (32) includes a second bipolar junction transistor (321), a second bias resistor (322), a second current-limiting resistor (323), and a second voltage-regulating unit (324). A collector of the second bipolar junction transistor (321) is electrically connected to an output end of the second current-limiting circuit (32). One end of the second bias resistor (322) is electrically connected to a base of the second bipolar junction transistor (321), and the other end of the second bias resistor (322) is electrically connected to the output end of the second current-limiting circuit (32). The second voltage-regulating unit (324) is electrically connected to the base of the second bipolar junction transistor (321), the output end of the second current-limiting circuit (32), and an emitter of the second bipolar junction transistor (321). The second voltage-regulating unit (324) is configured to control the current value outputted by the emitter of the second bipolar junction transistor (321). One end of the second current-limiting circuit (323) is electrically connected to the second voltage-regulating unit (324), and the other end of the second current-limiting circuit (323) is electrically connected to the input end of the second current-limiting circuit (32). A preferred embodiment of the second voltage-regulating unit (324) is a controllable Zener diode. An anode of the controllable Zener diode is electrically connected to the input end of the second current-limiting circuit (32), and the cathode of the controllable Zener diode is electrically connected to the base of the second bipolar junction transistor (321). A reference end of the controllable Zener diode is electrically connected to an output end of the second current-limiting resistor (323). Hereinafter, the second voltage-regulating unit (324) is described by using the controllable Zener diode as an example.

When the negative half-cycle current of the alternating current flows through the second diode (31) and into the second current-limiting circuit (32), the second current-limiting circuit (32) is operated in the same manner as that of the first current-limiting circuit (22). Thus, redundant description is omitted for simplicity. Therefore, the second current-limiting circuit (32) restricts the negative half-cycle current to an average current value. Since the second current-limiting circuit (32) of the present embodiment is constituted of fewer elements, total manufacturing costs are reduced to make the present invention more competitive. Furthermore, the manufacturing procedure is also simplified.

One end of the current input section (4) is electrically connected to the input power supply, and the other end of the current input section (4) is electrically connected to the first input end (23) and the second input end (33) and coupled to a first connecting point (11). One end of the current output section (5) is electrically connected to a load (6), and the other end of the current output section (5) is electrically connected to the first output end (24) and the second output end (34) and coupled to a second connecting point (12). In the present embodiment, the load (6) means an object which consumes electricity for its operation, such as a television, electric fan, electric lamp or the like.

The current input section (4) are electrically connected to the first input end (23) and the second input end (33) and coupled to the first junction (11). The current output section (5) is electrically connected to the first output end (24) and the second output end (34) and coupled to the second connecting point (12). With this arrangement, when the alternating current flows through the first diode (21) and the second diode (31), the alternating current is divided into a positive half-cycle current and a negative half-cycle current. Since the difference of the phase angle between the positive half-cycle current and the negative half-cycle current is 180 degree, the positive half-cycle current and the negative half-cycle current flow to the second connecting point (12) to form an electric current having a continuous periodic wave for a load. Thus, a phase angle error will not be generated in the alternating current to adversely affect the load (6).

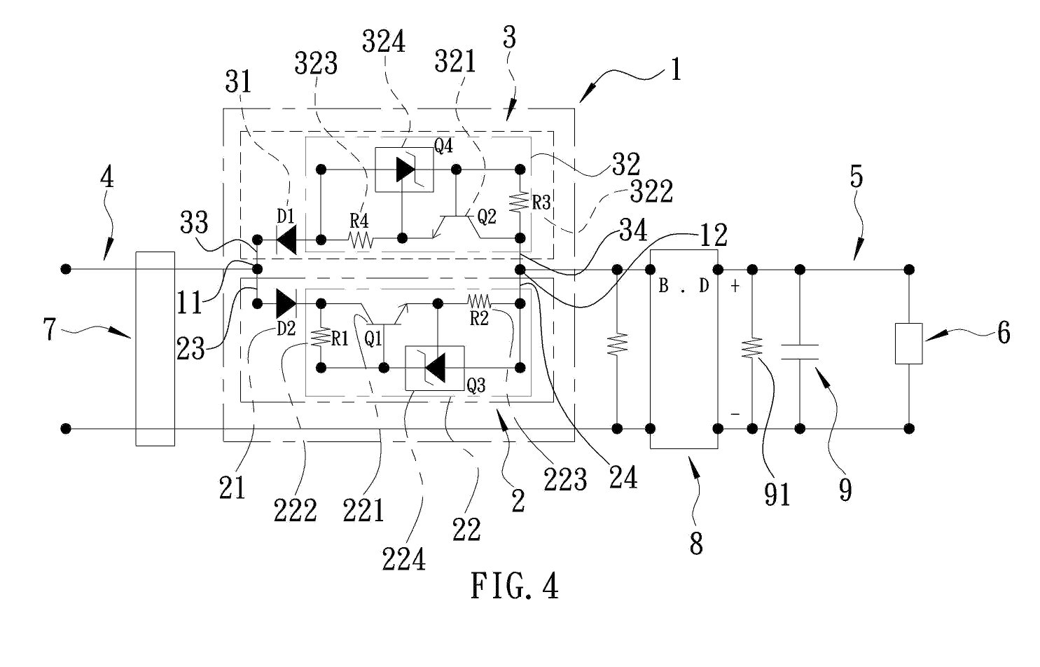

Please refer to FIG. 4, which shows another embodiment of the present invention. In the present embodiment, a voltage-controlling unit (7) is provided. One end of the voltage-controlling unit (7) is electrically connected to the current input section (4), and the other end of the voltage-controlling unit (7) is electrically connected to the input power supply. The voltage-controlling unit (7) is configured to control the voltage V of the input power supply and to change the value Ve-r. As a result, after the alternating current flows through the first current-limiting circuit (22) and the second current-limiting circuit (32), the average current value is changed, thereby controlling the current value flowing into the load (6). When the load (6) is an electric bulb, the voltage-controlling unit (7) is configured to control the brightness of the electric bulb, thereby saving electricity. The voltage-controlling unit (7) may be a variable resistor. By changing the resistance of the variable resistor, the voltage of the input power supply can be changed. A preferred embodiment of the voltage-controlling unit (7) may be a bidirectional silicon controlled rectifier for adjusting the voltage of the input power supply.

Please refer to FIG. 1, which shows another embodiment of the present invention. In the present embodiment, a rectifier (8) is provided. One end of the rectifier (8) is electrically connected to the load (6), and the other end of the rectifier (8) is electrically connected to the current output section (5). When the input power supply generates an alternating current, the rectifier (8) converts the alternating current into a direct current for the load (6). In a further embodiment of the present invention, a capacitor (9) is provided. One end of the capacitor (9) is electrically connected to the load (6), and the other end of the capacitor (9) is electrically connected to the rectifier (8). By using the capacitor (9), the current flowing into the load (6) becomes more stable. Furthermore, a bleeder resistor (91) is provided to be electrically connected to the capacitor (9). The bleeder resistor (91) is configured to bleed excess charge stored in the capacitor (9) when the alternating current regulating means (1) is inactive. In this way, it is safer to use the alternating current regulating means (1) the next time.

According to the above, the present invention has real industrial applicability that has not been seen or used in public. Further, the present invention is non-obviousness, so that it conforms to the requirements for a patent.

The above disclosed embodiment is merely a preferred embodiment of the present invention. Various equivalent variations and modifications may be designed as known to those skilled in the art in view of the teachings of the present invention. Thus, all such variations and equivalent modifications are also embraced within the scope of the invention as defined in the appended claims.

What is claimed is:

1. An alternating current regulating means, including:
a positive half-cycle current-limiting circuit comprising a first diode, a first current-limiting circuit, a first input end and a first output end, a cathode of the first diode being electrically connected to an input end of the first current-limiting circuit, an anode of the first diode being electrically connected to the first input end, an output end of the first current-limiting circuit being electrically connected to the first output end;
a negative half-cycle current-limiting circuit comprising a second diode, a second current-limiting circuit, a second input end and a second output end, an anode of the second diode being electrically connected to an input end of the second current-limiting circuit, a cathode of the second diode being electrically connected to the second input end, an output end of the second current-limiting circuit being electrically connected to the second output end;
a current input section, one end of the current input section being electrically connected to the first input end and the second input end and coupled to a first connecting point, the other end of the current input section being electrically connected to an input power supply; and
a current output section, one end of the current output section being electrically connected to the first output end and the second output end and coupled to a second connecting point, the other end of the current output section being electrically connected to a load.

2. The alternating current regulating means according to claim 1, wherein the first current-limiting circuit includes a first bipolar junction transistor, a first bias resistor, a first current-limiting resistor, and a first voltage-regulating unit, a base of the first bipolar junction transistor is electrically connected to an input end of the first current-limiting circuit, one end of the first bias resistor is electrically connected to a base of the first bipolar junction transistor, the other end of the first bias resistor is electrically connected to the input end of the first current-limiting circuit, one end of the first current-limiting resistor is electrically connected to an emitter of the first bipolar junction transistor, the other end of the first current-limiting resistor is electrically connected to the output end of the first current-limiting circuit, the first voltage-regulating unit is electrically connected to the base of the first bipolar junction transistor, the output end of the first current-limiting circuit and the emitter of the first bipolar junction transistor, the first voltage-regulating unit is configured to control the current value outputted by the emitter of the first bipolar junction transistor.

3. The alternating current regulating means according to claim 1, wherein the second current-limiting circuit includes a second bipolar junction transistor, a second bias resistor, a second current-limiting resistor, and a second voltage-regulating unit, a base of the second bipolar junction transistor is electrically connected to an output end of the second current-limiting circuit, one end of the second bias resistor is electrically connected to a base of the second bipolar junction transistor, the other end of the second bias resistor is electrically connected to the output end of the second current-limiting circuit, one end of the second current-limiting resistor is electrically connected to an emitter of the second bipolar junction transistor, the other end of the second current-limiting resistor is electrically connected to the input end of the second current-limiting circuit, the second voltage-regulating unit is electrically connected to the base of the second bipolar junction transistor, the input end of the second current-limiting circuit and the emitter of the second bipolar junction transistor, the second voltage-regulating unit is configured to control the current value outputted by the emitter of the second bipolar junction transistor.

4. The alternating current regulating means according to claim 2, wherein the second current-limiting circuit includes a second bipolar junction transistor, a second bias resistor, a second current-limiting resistor, and a second voltage-regulating unit, a base of the second bipolar junction transistor is electrically connected to an output end of the second current-limiting circuit, one end of the second bias resistor is electrically connected to a base of the second bipolar junction transistor, the other end of the second bias resistor is electrically connected to the output end of the second current-limiting circuit, one end of the second current-limiting resistor is electrically connected to an emitter of the second bipolar junction transistor, the other end of the second current-limiting resistor is electrically connected to the input end of the second current-limiting circuit, the second voltage-regulating unit is electrically connected to the base of the second bipolar junction transistor, the input end of the second current-limiting circuit and the emitter of the second bipolar junction transistor, the second voltage-regulating unit is configured to control the current value outputted by the emitter of the second bipolar junction transistor.

5. The alternating current regulating means according to claim 2, wherein the first voltage-regulating unit is a controllable Zener diode (also referred to as “TL431”), an anode of the controllable Zener diode is electrically connected to an output end of the first current-limiting circuit, a cathode of the controllable Zener diode is electrically connected to the base of the first bipolar junction transistor, a reference end of the controllable Zener diode is electrically connected to the input end of the first current-limiting resistor, the second voltage-regulating unit is a controllable Zener diode (also referred to as “TL431”), an anode of the controllable Zener diode is electrically connected to an input end of the second current-limiting circuit, and a cathode of the controllable Zener diode is electrically connected to the base of the second bipolar junction transistor, a reference end of the controllable Zener diode is electrically connected to an output end of the second current-limiting resistor.

6. The alternating current regulating means according to claim 3, wherein the first voltage-regulating unit is a controllable Zener diode (also referred to as “TL431”), an anode of the controllable Zener diode is electrically connected to the an output end of the first current-limiting circuit, a cathode of the controllable Zener diode is electrically connected to the base of the first bipolar junction transistor, a reference end of the controllable Zener diode is electrically connected to the input end of the first current-limiting resistor, the second voltage-regulating unit is a controllable Zener diode (also referred to as “TL431”), an anode of the controllable Zener diode is electrically connected to an input end of the second current-limiting circuit, and a cathode of the controllable Zener diode is electrically connected to the base of the second bipolar junction transistor, a reference end of the controllable Zener diode is electrically connected to an output end of the second current-limiting resistor.

7. The alternating current regulating means according to claim 1, further including a voltage-controlling unit, one end of the voltage-controlling unit being electrically connected to the current input section, and the other end of the voltage-controlling unit being electrically connected to the input power supply.

8. The alternating current regulating means according to claim 7, wherein the voltage-controlling unit is a bidirectional silicon controlled rectifier.

9. The alternating current regulating means according to claim 1, further including a rectifier, one end of the rectifier being electrically connected to the current output section, and the other end of the rectifier being electrically connected to a load.

10. The alternating current regulating means according to claim 9, further including a capacitor and a bleeder resistor, one end of the capacitor being electrically connected to the rectifier, the other end of the capacitor being electrically connected to the load, the bleeder resistor being electrically connected to the capacitor, the bleeder resistor being configured to bleed charges stored in the capacitor when the alternating current regulating means is inactive.
